(19) United States
(12) Patent Application Publication
(10) Pub. No.: US 2001/0044835 A1
(43) Pub. Date: Nov. 22, 2001

(54) Selecting content to be communicated based on automatic detection of communication bandwidth

(76) Inventors: Joseph Frank Schober, Falls Church, VA (US); Zhihong Zhang, Great Falls, VA (US); Bruce L. Geisert, Arlington, VA (US)

Correspondence Address: W. KARL RENNER, Fish & Richardson P.C., 601 Thirteenth Street, NW, Washington, DC, 20005, US

(21) Appl. No.: 09/852,744

(22) Filed: May 11, 2001

Related U.S. Application Data
(60) Provisional application No. 60/204,759, filed on May 17, 2000.
(60) Provisional application No. 60/207,318, filed on May 30, 2000.

(51) Int. Cl. G06F 15/16

(52) U.S. Cl. 709/217

(57) ABSTRACT

Communicating content typically includes automatically determining an available bandwidth between a recipient and a provider. Based on the determined available bandwidth, content is selected to be communicated between the recipient and the provider. The content then is communicated between the provider and the recipient. The available bandwidth may be determined automatically using at least one iteration that includes transmitting a predetermined amount of data to the recipient. An amount of time taken for the predetermined amount of data to be received by the recipient is monitored, and, based on the predetermined amount of data and the amount of time taken for the data to be received by the recipient, the available bandwidth is calculated.

### CROSS REFERENCE TO RELATED APPLICATIONS

This application claims priority from U.S. Provisional Application No. 60/204,759, filed May 17, 2000, and titled “Component Installation Tool,” and from U.S. Provisional Application No. 60/207,318, filed May 30, 2000, and titled “Automatic Detection of Communication Speed,” both of which are incorporated by reference.

### TECHNICAL FIELD

This invention relates to selecting content to be communicated based on automatic detection of communication bandwidth.

### BACKGROUND

The need and the ability of conventional systems, methods, and computer programs to determine the available bandwidth between a host computer and a client computer has become increasingly important for a variety of reasons. For instance, the speed at which the host and the client communicate may depend on the available bandwidth.

### SUMMARY

In one general aspect, communicating content typically includes automatically determining an available bandwidth between a recipient and a provider. Based on the determined available bandwidth, content is selected to be communicated between the recipient and the provider. The content then is communicated between the provider and the recipient.

Implementations may include one or more of the following features. For example, the available bandwidth may be determined automatically using at least one iteration that includes transmitting a predetermined amount of data to the recipient. An amount of time taken for the predetermined amount of data to be received by the recipient is monitored, and, based on the predetermined amount of data and the amount of time taken for the data to be received by the recipient, the available bandwidth is calculated. The predetermined amount of data may be based on a prediction of a communication device used by the recipient to communicate. The available bandwidth also may be calculated at the provider based on the amount of data and the amount of time for the transmission.

Additionally or alternatively, the available bandwidth may be determined automatically by transmitting, to the recipient, information indicating the amount of data being communicated and then calculating the available bandwidth at the recipient based on the information indicating the amount of data communicated and the amount of time for the transmission.

Additionally or alternatively, the available bandwidth may be determined automatically by transmitting a predetermined amount of data to the recipient and then retransmitting the data from the recipient to the provider. The amount of time taken for the data to be received by the recipient, re-transmitted to the provider, and received by the provider may be monitored. Based on the predetermined amount of the data and the amount of time taken for the data to be received by the recipient, re-transmitted to the provider, and received by the provider, the available bandwidth may be calculated. The available bandwidth may be calculated at the provider.

Additionally or alternatively, the available bandwidth may be determined automatically by transmitting, to the recipient, information indicating the amount of data being communicated and calculating the available bandwidth at the recipient based on the information indicating the amount of data communicated and the amount of time taken for the data to be received by the recipient, re-transmitted to the provider, and received by the provider.

The available bandwidth may be determined automatically by further adjusting the amount of the data based on the available bandwidth calculated and repeating the iteration using the adjusted amount of the data. The amount of the data may be adjusted by increasing or decreasing the amount of the data.

In another implementation, the available bandwidth may be determined automatically by automatically detecting the available bandwidth between the recipient and the provider. The available bandwidth may be detected automatically when the recipient initially establishes communications with the provider. Additionally or alternatively, the available bandwidth may be detected automatically when the recipient requests content from the provider after the recipient initially establishes communications with the provider.

Based on the determined available bandwidth, content may be selected among content of varying richnesses. Additionally or alternatively, based on the determined available bandwidth, content may be selected among content of varying formats. Selecting among content of varying formats may include selecting between at least content in a still picture format and content in a video format depending upon the determined available bandwidth.

The recipient may include a client and the provider may include a host. Alternatively, the recipient may include a host and the provider may include a client. Additionally or alternatively, the recipient and the provider may both be client devices that are capable of peer-to-peer communications.

In another implementation, the available bandwidth may be determined by automatically detecting the available bandwidth several times during one communication session between the recipient and the provider.

In another implementation, the available bandwidth may be determined by automatically determining the available bandwidth over a channel accommodating communications from the recipient to the provider and separately automatically determining the available bandwidth over a channel accommodating communications from the provider to the recipient.

In yet another implementation, the available bandwidth may be determined by automatically determining the available bandwidth over multiple channels between the recipient and the provider. The automatic determination may be performed simultaneously over the multiple channels. The content to be communicated over the multiple channels may be selected based on the available bandwidth determined over the multiple channels.

In still another implementation, the available bandwidth may be determined by automatically determining the available bandwidth simultaneously from the provider to the recipient and from the recipient to the provider.

These general and specific aspects may be implemented using a system, a method, or a computer program, or any combination of systems, methods, and computer programs.

Other features and advantages will be apparent from the description and drawings, and from the claims.

### DESCRIPTION OF DRAWINGS

FIG. 1 is a block diagram of a communications system.

FIGS. 2-5 are block diagrams of expansions of aspects of the communications system of FIG. 1.

FIG. 6 is a flow chart of a process for communicating content.

FIG. 7 is an expansion of the flow chart of FIG. 6.

FIG. 8 is an expansion of the flow chart of FIG. 6.

Like reference symbols in the various drawings indicate like elements.

### DETAILED DESCRIPTION

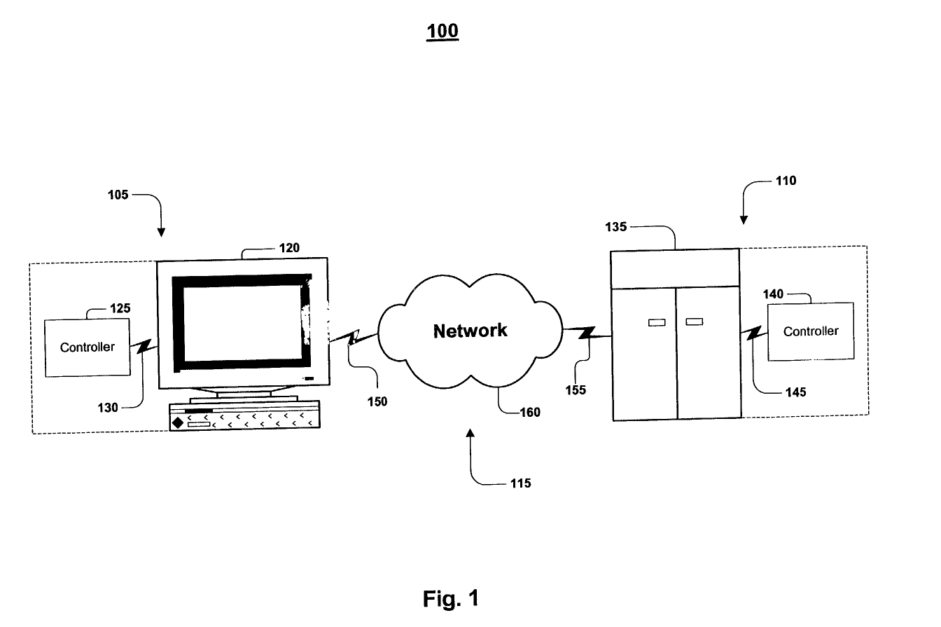

For illustrative purposes, FIGS. 1-5 shows an example of a communications system for implementing techniques for transferring electronic data. For brevity, several elements in the figures described below are represented as monolithic entities. However, as would be understood by one skilled in the art, these elements each may include numerous interconnected computers and components designed to perform a set of specified operations and/or may be dedicated to a particular geographical region.

Referring to FIG. 1, a communications system 100 is capable of delivering and exchanging data between a client system 105 and a host system 110 through a communications link 115. The client system 105 typically includes one or more client devices 120 and/or client controllers 125, and the host system 110 typically includes one or more host devices 135 and/or host controllers 140. For example, the client system 105 or the host system 110 may include one or more general-purpose computers (e.g., personal computers), one or more special-purpose computers (e.g., devices specifically programmed to communicate with each other and/or the client system 105 or the host system 110), or a combination of one or more general-purpose computers and one or more special-purpose computers. The client system 105 and the host system 110 may be arranged to operate within or in concert with one or more other systems, such as, for example, one or more LANs (“Local Area Networks”) and/or one or more WANs (“Wide Area Networks”).

The client device 120 (or the host device 135) is generally capable of executing instructions under the command of a client controller 125 (or a host controller 140). The client device 120 (or the host device 135) is connected to the client controller 125 (or the host controller 140) by a wired or wireless data pathway 130 or 145 capable of delivering data.

The client device 120, the client controller 125, the host device 135, and the host controller 140 each typically include one or more hardware components and/or software components. An example of a client device 120 or a host device 135 is a general-purpose computer (e.g., a personal computer) capable of responding to and executing instructions in a defined manner. Other examples include a special-purpose computer, a workstation, a server, a device, a component, other physical or virtual equipment or some combination thereof capable of responding to and executing instructions. The client device 120 and the host device 135 may include devices that are capable of peer-to-peer communications.

An example of client controller 125 or a host controller 140 is a software application loaded on the client device 120 or the host device 135 for commanding and directing communications enabled by the client device 120 or the host device 135. Other examples include a program, a piece of code, an instruction, a device, a computer, a computer system, or a combination thereof, for independently or collectively instructing the client device 120 or the host device 135 to interact and operate as described. The client controller 125 and the host controller 140 may be embodied permanently or temporarily in any type of machine, component, physical or virtual equipment, storage medium, or propagated signal capable of providing instructions to the client device 120 or the host device 135.

The communications link 115 typically includes a delivery network 160 making a direct or indirect communication between the client system 105 and the host system 110, irrespective of physical separation. Examples of a delivery network 160 include the Internet, the World Wide Web, WANs, LANs, analog or digital wired and wireless telephone networks (e.g. PSTN, ISDN, and xDSL), radio, television, cable, satellite, and/or any other delivery mechanism for carrying data. The communications link 115 may include communication pathways 150, 155 that enable communications through the one or more delivery networks 160 described above. Each of the communication pathways 150, 155 may include, for example, a wired, wireless, cable or satellite communication pathway.

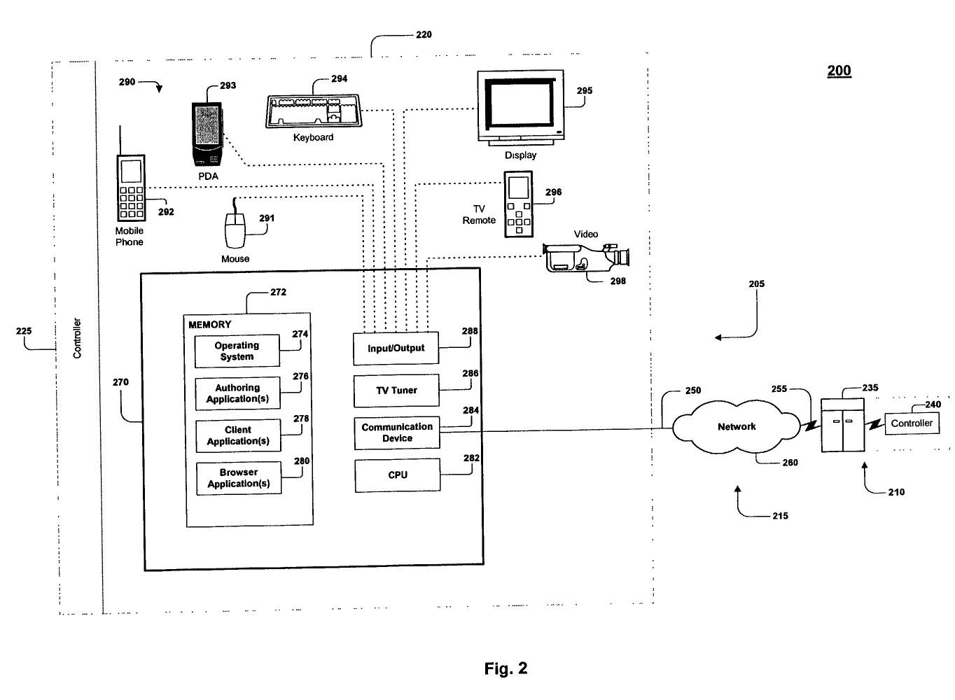

FIG. 2 illustrates a communications system 200 including a client system 205 communicating with a host system 210 through a communications link 215. Client system 205 typically includes one or more client devices 220 and one or more client controllers 225 for controlling the client devices 220. Host system 210 typically includes one or more host devices 235 and one or more host controllers 240 for controlling the host devices 235. The communications link 215 may include communication pathways 250, 255 enabling communications through the one or more delivery networks 260.

Examples of each element within the communications system of FIG. 2 are broadly described above with respect to FIG. 1. In particular, the host system 210 and communications link 215 typically have attributes comparable to those described with respect to host system 110 and communications link 115 of FIG. 1. Likewise, the client system 205 of FIG. 2 typically has attributes comparable to and illustrates one possible implementation of the client system 105 of FIG. 1.

The client device 220 typically includes a general-purpose computer 270 having an internal or external storage 272 for storing data and programs such as an operating system 274 (e.g., DOS, Windows™, Windows 95™, Windows 98™, Windows 2000™, Windows Me™, Windows XP™, Windows NT™, OS/2, or Linux) and one or more application programs. Examples of application programs include authoring applications 276 (e.g., word processing, database programs, spreadsheet programs, or graphics programs) capable of generating documents or other electronic content; client applications 278 (e.g., AOL client, CompuServe client, AIM client, AOL TV client, or ISP client) capable of communicating with other computer users, accessing various computer resources, and viewing, creating, or otherwise manipulating electronic content; and browser applications 280 (e.g., Netscape's Navigator or Microsoft's Internet Explorer) capable of rendering standard Internet content.

The general-purpose computer 270 also includes a central processing unit 282 (CPU) for executing instructions in response to commands from the client controller 225. In one implementation, the client controller 225 includes one or more of the application programs installed on the internal or external storage 272 of the general-purpose computer 270. In another implementation, the client controller 225 includes application programs externally stored in and performed by one or more device(s) external to the general-purpose computer 270.

The general-purpose computer typically will include a communication device 284 for sending and receiving data. One example of the communication device 284 is a modem. Other examples include a transceiver, a set-top box, a communication card, a satellite dish, an antenna, or another network adapter capable of transmitting and receiving data over the communications link 215 through a wired or wireless data pathway 250. The general-purpose computer 270 also may include a TV (“television”) tuner 286 for receiving television programming in the form of broadcast, satellite, and/or cable TV signals. As a result, the client device 220 can selectively and/or simultaneously display network content received by communications device 284 and television programming content received by the TV tuner 286.

The general-purpose computer 270 typically will include an input/output interface 288 for wired or wireless connection to various peripheral devices 290. Examples of peripheral devices 290 include, but are not limited to, a mouse 291, a mobile phone 292, a personal digital assistant 293 (PDA), an MP3 player (not shown), a keyboard 294, a display monitor 295 with or without a touch screen input, a TV remote control 296 for receiving information from and rendering information to subscribers, and an audiovisual input device 298.

Although FIG. 2 illustrates devices such as a mobile telephone 292, a PDA 293, an MP3 player (not shown), and a TV remote control 296 as being peripheral with respect to the general-purpose computer 270, in another implementation, such devices may themselves include the functionality of the general-purpose computer 270 and operate as the client device 220. For example, the mobile phone 292 or the PDA 293 may include computing and networking capabilities and function as a client device 220 by accessing the delivery network 260 and communicating with the host system 210. Furthermore, the client system 205 may include one, some or all of the components and devices described above.

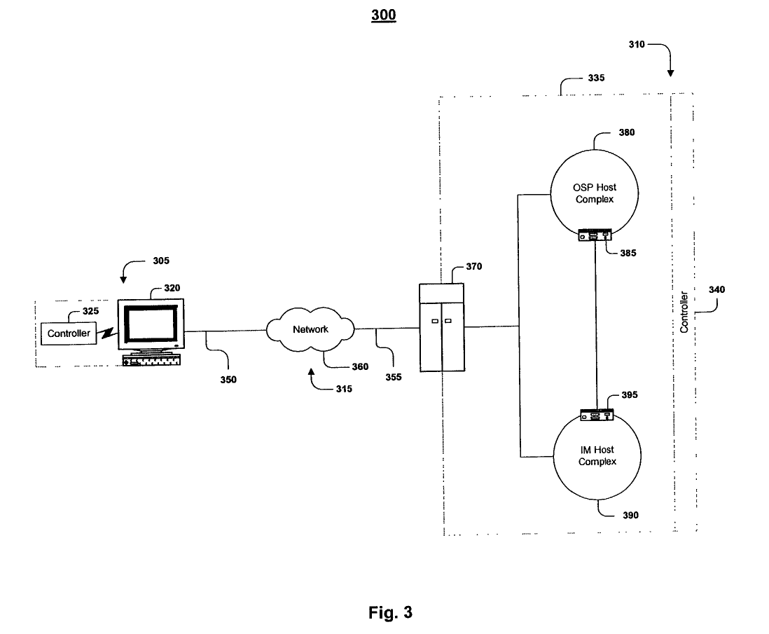

Referring to FIG. 3, a communications system 300 is capable of delivering and exchanging information between a client system 305 and a host system 310 through a communication link 315. Client system 305 typically includes one or more client devices 320 and one or more client controllers 325 for controlling the client devices 320. Host system 310 typically includes one or more host devices 335 and one or more host controllers 340 for controlling the host devices 335. The communications link 315 may include communication pathways 350, 355 enabling communications through the one or more delivery networks 360.

Examples of each element within the communications system of FIG. 3 are broadly described above with respect to FIGS. 1 and 2. In particular, the client system 305 and the communications link 315 typically have attributes comparable to those described with respect to client systems 105 and 205 and communications links 115 and 215 of FIGS. 1 and 2. Likewise, the host system 310 of FIG. 3 may have attributes comparable to and illustrates one possible implementation of the host systems 110 and 210 shown in FIGS. 1 and 2.

The host system 310 includes a host device 335 and a host controller 340. The host controller 340 is generally capable of transmitting instructions to any or all of the elements of the host device 335. For example, in one implementation, the host controller 340 includes one or more software applications loaded on the host device 335. In other implementations, as described above, the host controller 340 may include any of several other programs, machines, and devices operating independently or collectively to control the host device 335.

The host device 335 includes a login server 370 for enabling access by subscribers and for routing communications between the client system 305 and other elements of the host device 335. The host device 335 also includes various host complexes such as the depicted OSP (“Online Service Provider”) host complex 380 and IM (“Instant Messaging”) host complex 390. To enable access to these host complexes by subscribers, the client system 305 includes communication software, for example, an OSP client application and an IM client application. The OSP and IM communication software applications are designed to facilitate the subscriber's interactions with the respective services and, in particular, may provide access to all the services available within the respective host complexes.

Typically, the OSP host complex 380 supports different services, such as email, discussion groups, chat, news services, and Internet access. The OSP host complex 380 is generally designed with an architecture that enables the machines within the OSP host complex 380 to communicate with each other and employs certain protocols (i.e., standards, formats, conventions, rules, and structures) to transfer data. The OSP host complex 380 ordinarily employs one or more OSP protocols and custom dialing engines to enable access by selected client applications. The OSP host complex 380 may define one or more specific protocols for each service based on a common, underlying proprietary protocol.

The IM host complex 390 is generally independent of the OSP host complex 380, and supports instant messaging services irrespective of a subscriber's network or Internet access. Thus, the IM host complex 390 allows subscribers to send and receive instant messages, whether or not they have access to any particular ISP. The IM host complex 390 may support associated services, such as administrative matters, advertising, directory services, chat, and interest groups related to the instant messaging. The IM host complex 390 has an architecture that enables all of the machines within the IM host complex to communicate with each other. To transfer data, the IM host complex 390 employs one or more standard or exclusive IM protocols.

The host device 335 may include one or more gateways that connect and therefore link complexes, such as the OSP host complex gateway 385 and the IM host complex gateway 395. The OSP host complex gateway 385 and the IM host complex gateway 395 may directly or indirectly link the OSP host complex 380 with the IM host complex 390 through a wired or wireless pathway. Ordinarily, when used to facilitate a link between complexes, the OSP host complex gateway 385 and the IM host complex gateway 395 are privy to information regarding the protocol type anticipated by a destination complex, which enables any necessary protocol conversion to be performed incident to the transfer of data from one complex to another. For instance, the OSP host complex 380 and IM host complex 390 generally use different protocols such that transferring data between the complexes requires protocol conversion by or at the request of the OSP host complex gateway 385 and/or the IM host complex gateway 395.

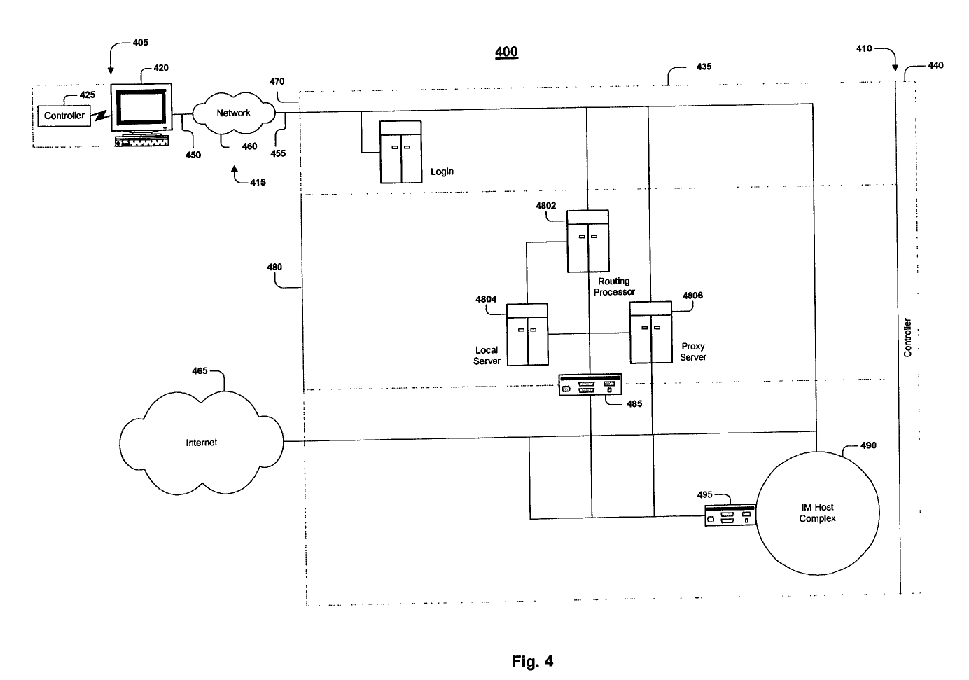

Referring to FIG. 4, a communications system 400 is capable of delivering and exchanging information between a client system 405 and a host system 410 through a communication link 415. Client system 405 typically includes one or more client devices 420 and one or more client controllers 425 for controlling the client devices 420. Host system 410 typically includes one or more host devices 435 and one or more host controllers 440 for controlling the host devices 435. The communications link 415 may include communication pathways 450, 455 enabling communications through the one or more delivery networks 460. As shown, the client system 405 may access the Internet 465 through the host system 410.

Examples of each element within the communications system of FIG. 4 are broadly described above with respect to FIGS. 1-3. In particular, the client system 405 and the communications link 415 typically have attributes comparable to those described with respect to client systems 105, 205, and 305 and communications links 115, 215, and 315 of FIGS. 1-3. Likewise, the host system 410 of FIG. 4 may have attributes comparable to and illustrates one possible implementation of the host systems 110, 210, and 310 shown in FIGS. 1-3. FIG. 4 describes an aspect of the host system 410, focusing primarily on one particular implementation of OSP host complex 480.

The client system 405 includes a client device 420 and a client controller 425. The client controller 425 is generally capable of establishing a connection to the host system 410, including the OSP host complex 480, the IM host complex 490 and/or the Internet 465. In one implementation, the client controller 425 includes an OSP application for communicating with servers in the OSP host complex 480 using exclusive OSP protocols. The client controller 425 also may include applications, such as an IM client application, and/or an Internet browser application, for communicating with the IM host complex 490 and the Internet 465.

The host system 410 includes a host device 435 and a host controller 440. The host controller 440 is generally capable of transmitting instructions to any or all of the elements of the host device 435. For example, in one implementation, the host controller 440 includes one or more software applications loaded on one or more elements of the host device 435. In other implementations, as described above, the host controller 440 may include any of several other programs, machines, and devices operating independently or collectively to control the host device 435.

The host system 410 includes a login server 470 capable of enabling communications with and authorizing access by client systems 405 to various elements of the host system 410, including an OSP host complex 480 and an IM host complex 490. The login server 470 may implement one or more authorization procedures to enable simultaneous access to the OSP host complex 480 and the IM host complex 490. The OSP host complex 480 and the IM host complex 490 are connected through one or more OSP host complex gateways 485 and one or more IM host complex gateways 495. Each OSP host complex gateway 485 and IM host complex gateway 495 may perform any protocol conversions necessary to enable communications between the OSP host complex 480, the IM host complex 490, and the Internet 465.

The OSP host complex 480 supports a set of services from one or more servers located internal to and external from the OSP host complex 480. Servers external to the OSP host complex 480 generally may be viewed as existing on the Internet 465. Servers internal to the OSP complex 480 may be arranged in one or more configurations. For example, servers may be arranged in centralized or localized clusters in order to distribute servers and subscribers within the OSP host complex 480.

In one implementation of FIG. 4, the OSP host complex 480 includes a routing processor 4802. In general, the routing processor 4802 will examine an address field of a data request, use a mapping table to determine the appropriate destination for the data request, and direct the data request to the appropriate destination. In a packet-based implementation, the client system 405 may generate information requests, convert the requests into data packets, sequence the data packets, perform error checking and other packet-switching techniques, and transmit the data packets to the routing processor 4802. Upon receiving data packets from the client system 405, the routing processor 4802 may directly or indirectly route the data packets to a specified destination within or outside of the OSP host complex 480. For example, in the event that a data request from the client system 405 can be satisfied locally, the routing processor 4802 may direct the data request to a local server 4804. In the event that the data request cannot be satisfied locally, the routing processor 4802 may direct the data request externally to the Internet 465 or the IM host complex 490 through the gateway 485.

The OSP host complex 480 also includes a proxy server 4806 for directing data requests and/or otherwise facilitating communication between the client system 405 and the Internet 465. The proxy server 4806 may include an IP (“Internet Protocol”) tunnel for converting data from OSP protocol into standard Internet protocol and transmitting the data to the Internet 465. The IP tunnel also converts data received from the Internet 465 in the standard Internet protocol back into the OSP protocol and sends the converted data to the routing processor 4802 for delivery back to the client system 405.

The proxy server 4806 also may allow the client system 405 to use standard Internet protocols and formatting to access the OSP host complex 480 and the Internet 465. For example, the subscriber may use an OSP TV client application having an embedded browser application installed on the client system 405 to generate a request in standard Internet protocol, such as HTTP (“HyperText Transport Protocol”). In a packet-based implementation, data packets may be encapsulated inside a standard Internet tunneling protocol, such as, for example, UDP (“User Datagram Protocol”) and routed to the proxy server 4806. The proxy server 4806 may include an L2TP (“Layer Two Tunneling Protocol”) tunnel capable of establishing a point-to-point protocol (PPP) session with the client system 405.

The proxy server 4806 also may act as a buffer between the client system 405 and the Internet 465, and may implement content filtering and time saving techniques. For example, the proxy server 4806 can check parental controls settings of the client system 405 and request and transmit content from the Internet 465 according to the parental control settings. In addition, the proxy server 4806 may include one or more caches for storing frequently accessed information. If requested data is determined to be stored in the caches, the proxy server 4806 may send the information to the client system 405 from the caches and avoid the need to access the Internet 465.

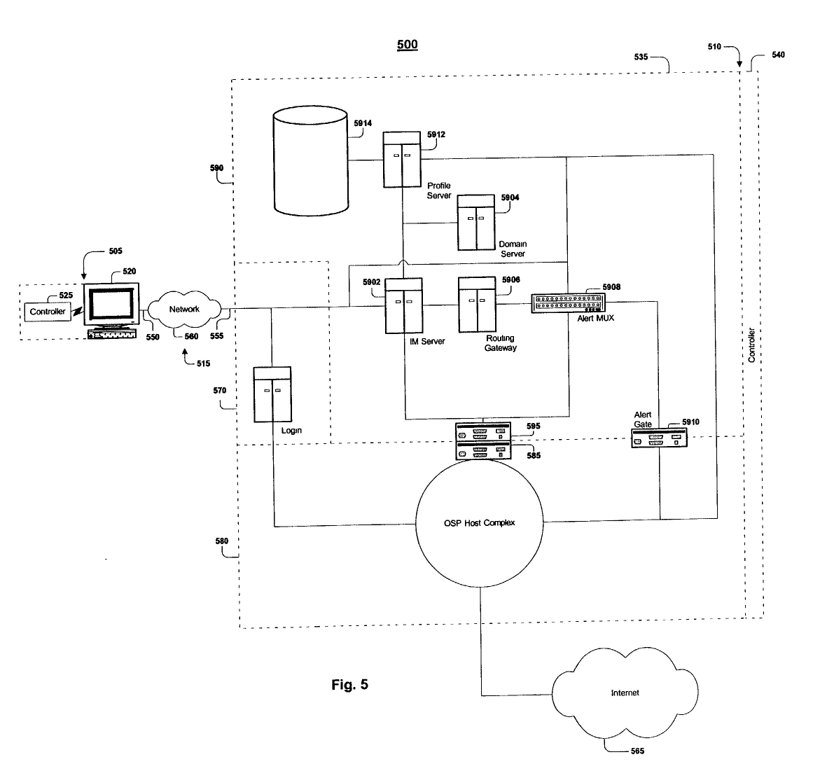

Referring to FIG. 5, a communications system 500 is capable of delivering and exchanging information between a client system 505 and a host system 510 through a communication link 515. Client system 505 typically includes one or more client devices 520 and one or more client controllers 525 for controlling the client devices 520. Host system 510 typically includes one or more host devices 535 and one or more host controllers 540 for controlling the host devices 535. The communications link 515 may include communication pathways 550, 555 enabling communications through the one or more delivery networks 560. As shown, the client system 505 may access the Internet 565 through the host system 510.

Examples of each element within the communications system of FIG. 5 are broadly described above with respect to FIGS. 1-4. In particular, the client system 505 and the communications link 515 typically have attributes comparable to those described with respect to client systems 105, 205, 305, and 405 and communications links 115, 215, 315, and 415 of FIGS. 1-4. Likewise, the host system 510 of FIG. 5 may have attributes comparable to and illustrates one possible implementation of the host systems 110, 210, 310, and 410 shown in FIGS. 1-4. FIG. 5 describes an aspect of the host system 510, focusing primarily on one particular implementation of IM host complex 590.

The client system 505 includes a client device 520 and a client controller 525. The client controller 525 is generally capable of establishing a connection to the host system 510, including the OSP host complex 580, the IM host complex 590 and/or the Internet 565. In one implementation, the client controller 525 includes an IM application for communicating with servers in the IM host complex 590 utilizing exclusive IM protocols. The client controller 525 also may include applications, such as an OSP client application, and/or an Internet browser application for communicating with the OSP host complex 580 and the Internet 565, respectively.

The host system 510 includes a host device 535 and a host controller 540. The host controller 540 is generally capable of transmitting instructions to any or all of the elements of the host device 535. For example, in one implementation, the host controller 540 includes one or more software applications loaded on one or more elements of the host device 535. However, in other implementations, as described above, the host controller 540 may include any of several other programs, machines, and devices operating independently or collectively to control the host device 535.

The host system 510 includes a login server 570 capable of enabling communications with and authorizing access by client systems 505 to various elements of the host system 510, including an OSP host complex 580 and an IM host complex 590. The login server 570 may implement one or more authorization procedures to enable simultaneous access to the OSP host complex 580 and the IM host complex 590. The OSP host complex 580 and the IM host complex 590 are connected through one or more OSP host complex gateways 585 and one or more IM host complex gateways 595. Each OSP host complex gateway 585 and IM host complex gateway 595 may perform any protocol conversions necessary to enable communication between the OSP host complex 580, the IM host complex 590, and the Internet 565.

To access the IM host complex 590 to begin an instant messaging session, the client system 505 establishes a connection to the login server 570. The login server 570 typically determines whether the particular subscriber is authorized to access the IM host complex 590 by verifying a subscriber identification and password. If the subscriber is authorized to access the IM host complex 590, the login server 570 employs a hashing technique on the subscriber's screen name to identify a particular IM server 5902 for use during the subscriber's session. The login server 570 provides the client system 505 with the IP address of the particular IM server 5902, gives the client system 505 an encrypted key (i.e., a cookie), and breaks the connection. The client system 505 then uses the IP address to establish a connection to the particular IM server 5902 through the communications link 515, and obtains access to that IM server 5902 using the encrypted key. Typically, the client system 505 will be equipped with a Winsock API (“Application Programming Interface”) that enables the client system 505 to establish an open TCP connection to the IM server 5902.

Once a connection to the IM server 5902 has been established, the client system 505 may directly or indirectly transmit data to and access content from the IM server 5902 and one or more associated domain servers 5904. The IM server 5902 supports the fundamental instant messaging services and the domain servers 5904 may support associated services, such as, for example, administrative matters, directory services, chat and interest groups. In general, the purpose of the domain servers 5904 is to lighten the load placed on the IM server 5902 by assuming responsibility for some of the services within the IM host complex 590. By accessing the IM server 5902 and/or the domain server 5904, a subscriber can use the IM client application to view whether particular subscribers (“buddies”) are online, exchange instant messages with particular subscribers, participate in group chat rooms, trade files such as pictures, invitations or documents, find other subscribers with similar interests, get customized news and stock quotes, and search the World Wide Web.

In the implementation of FIG. 5, the IM server 5902 is directly or indirectly connected to a routing gateway 5906. The routing gateway 5906 facilitates the connection between the IM server 5902 and one or more alert multiplexors 5908, for example, by serving as a link minimization tool or hub to connect several IM servers 5902 to several alert multiplexors 5908. In general, an alert multiplexor 5908 maintains a record of alerts and subscribers registered to receive the alerts.

Once the client system 505 is connected to the alert multiplexor 5908, a subscriber can register for and/or receive one or more types of alerts. The connection pathway between the client system 505 and the alert multiplexor 5908 is determined by employing another hashing technique at the IM server 5902 to identify the particular alert multiplexor 5908 to be used for the subscriber's session. Once the particular multiplexor 5908 has been identified, the IM server 5902 provides the client system 505 with the IP address of the particular alert multiplexor 5908 and gives the client system 505 an encrypted key (i.e., a cookie). The client system 505 then uses the IP address to connect to the particular alert multiplexor 5908 through the communication link 515 and obtains access to the alert multiplexor 5908 using the encrypted key.

The alert multiplexor 5908 is connected to an alert gate 5910 that, like the IM host complex gateway 595, is capable of performing the necessary protocol conversions to form a bridge to the OSP host complex 580. The alert gate 5910 is the interface between the IM host complex 590 and the physical servers, such as servers in the OSP host complex 580, where state changes are occurring. In general, the information regarding state changes will be gathered and used by the IM host complex 590. However, the alert multiplexor 5908 also may communicate with the OSP host complex 580 through the IM host complex gateway 595, for example, to provide the servers and subscribers of the OSP host complex 580 with certain information gathered from the alert gate 5910.

The alert gate 5910 can detect an alert feed corresponding to a particular type of alert.

The alert gate 5910 may include a piece of code (alert receive code) capable of interacting with another piece of code (alert broadcast code) on the physical server where a state change occurs. In general, the alert receive code installed on the alert gate 5910 instructs the alert broadcast code installed on the physical server to send an alert feed to the alert gate 5910 upon the occurrence of a particular state change. Upon detecting an alert feed, the alert gate 5910 contacts the alert multiplexor 5908, which in turn, informs the client system 505 of the detected alert feed.

In the implementation of FIG. 5, the IM host complex 590 also includes a subscriber is profile server 5912 connected to a database 5914 for storing large amounts of subscriber profile data. The subscriber profile server 5912 may be used to enter, retrieve, edit, manipulate, or otherwise process subscriber profile data. In one implementation, a subscriber's profile data includes, for example, the subscriber's buddy list, alert preferences, designated stocks, identified interests, and geographic location. The subscriber may enter, edit and/or delete profile data using an installed IM client application on the client system 505 to interact with the subscriber profile server 5912.

Because the subscriber's data is stored in the IM host complex 590, the subscriber does not have to reenter or update such information in the event that the subscriber accesses the IM host complex 590 using a new or a different client system 505. Accordingly, when a subscriber accesses the IM host complex 590, the IM server 5902 can instruct the subscriber profile server 5912 to retrieve the subscriber's profile data from the database 5914 and to provide, for example, the subscriber's buddy list to the IM server 5902 and the subscriber's alert preferences to the alert multiplexor 5908. The subscriber profile server 5912 also may communicate with other servers in the OSP host complex 580 to share subscriber profile data with other services. Alternatively, user profile data may be saved locally on the client device 505.

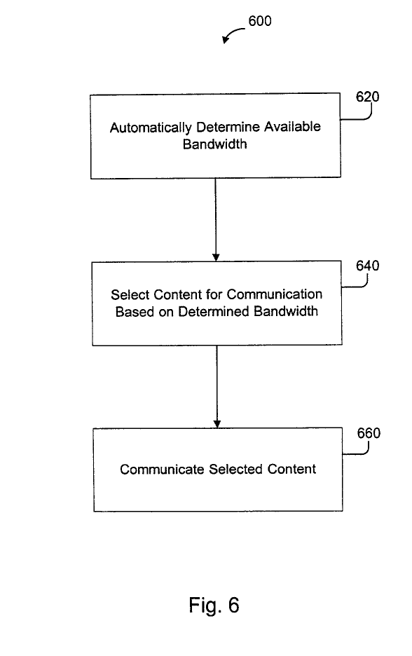

Referring to FIG. 6, content may be communicated according to process 600. The process 600 may performed, for example, by the systems described above with respect to FIGS. 1-5. For instance, process 600 may be performed by one or more of the client systems 105, 205, 305, 405, and 505 of FIGS. 1-5. Additionally or alternatively, process 600 may be performed by one or more of the host systems 110, 210, 310, 410, and 510 of FIGS. 1-5.

Process 600 also may be performed by any other hardware component, software component, or any combination of these capable of being programmed to receive, process, and send content in the manner described.

Process 600 typically includes automatically determining an available bandwidth between a recipient and a provider (step 620). Based on the determined available bandwidth, content is selected for communication between the recipient and the provider (step 640). The selected content then is communicated between the provider and the recipient (step 660).

Recipients and providers each may include one or more client devices 120, 220, 320, 420, and 520, and/or host devices 135, 235, 335, 435, and 535, as described above with respect to FIGS. 1-5. Additionally or alternatively, the recipient and the provider may both be client devices that are capable of peer-to-peer communications.

Automatically determining an available bandwidth between a recipient and a provider (step 620) may be performed in numerous ways. In one implementation, the provider may automatically send the recipient a request for the available bandwidth. The request may include a unique identifier (e.g., a 32 bit number) to identify the particular request. The recipient may choose how to respond to the provider's request. For example, the recipient may choose to report its known bandwidth to the provider. In the case where the recipient is using a low bandwidth communication device (e.g., a dial-up analog modem, a wireless modem, or a cellular modem), the recipient may report the communication device carrier rate as the determined bandwidth to the provider.

In another implementation, the recipient may choose to respond to the provider with cached results of a previous bandwidth determination. In yet another implementation, the recipient may choose to request a predetermined amount of data from the provider so the bandwidth may be calculated. In other implementations the provider may send a request to the recipient to determine the available bandwidth, with the request designating the method by which the recipient is to respond to the request.

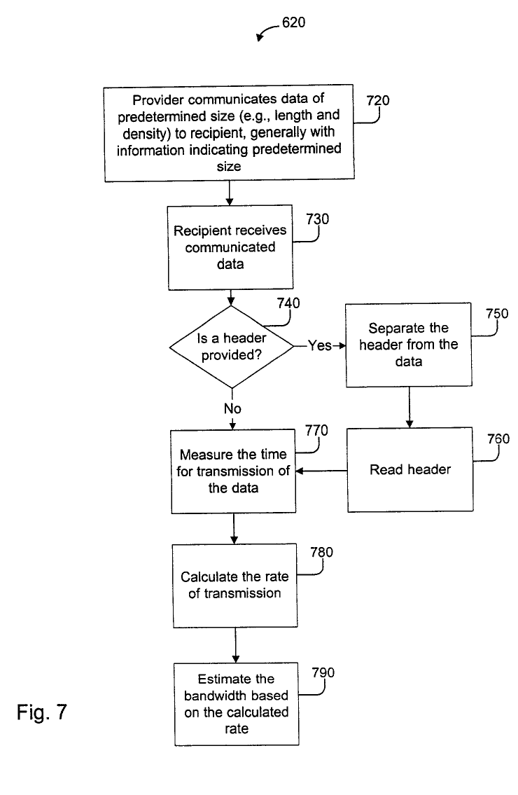

Referring to FIG. 7, for example, the provider may transmit a predetermined amount of data to the recipient (step 720). For instance, an amount of data may be transmitted along with a header or other indicator specifying the amount, such that the recipient is made aware of the amount. The amount of the data also may be requested by the recipient.

The recipient receives the transmitted data (step 730). If a header is provided (step 740), the recipient may separate the header from the data (step 750), and may read the header (step 760), which typically indicates the amount of data communicated. By monitoring or measuring the amount of time taken for the data to be received (step 770), the recipient may calculate the rate of transmission (step 780) based on the known amount of the data transmitted and the time needed to receive the data, and may estimate the available bandwidth (step 790) based on the calculated rate.

Calculating the rate of transmission (step 780) and/or estimating the available bandwidth (step 790) may be performed by the recipient and/or the provider. For instance, if the provider is a host and the recipient is a client, the client may determine the available bandwidth by performing the measurement, in which case the available bandwidth is typically known as the download bandwidth. In contrast, if the host determines the available bandwidth by performing the measurement, the available bandwidth is typically known as the upload bandwidth. These bi-directional calculations may be performed to determine the upload bandwidth and the download bandwidth separately, independently, or exclusively. For instance, the recipient may calculate an available download bandwidth and the provider may separately, independently, or exclusively calculate an available upload bandwidth. The recipient and the provider then may exchange the calculated information. This may be useful to determine when both the recipient and the provider may be using one or more different uplinks and downlinks that may have different available bandwidths such as when the content being communicated includes streaming media such as a real-time video conference.

Additionally or alternatively, the available bandwidth between a recipient and a provider may be calculated bi-directionally at the same time. For instance, the recipient may calculate an available download bandwidth at the same time that the provider calculates an available upload bandwidth. The calculated information then may be exchanged between the recipient and the provider. This may be useful to determine when the content being communicated includes streaming media such as a real-time video conference when both the recipient and the provider may be transmitting and receiving content at the same time.

Additionally or alternatively, the bandwidth may be determined by measuring the total time it takes for the recipient to receive a predetermined amount of data from the provider and for the provider to receive the same data back from the recipient. This calculation may be performed by the recipient and/or the provider.

The amount of data may be selected in numerous ways. For example, the recipient may indicate to the provider the amount of data to transmit. The recipient may request a particular amount of data based on any information known and/or available to the recipient. In this case, the amount of data may be based on information known to the recipient such as the type of connection or the type of communications hardware being used by the recipient. For instance, the recipient may request a particular amount of data if the recipient is using a low-bandwidth communication device to communicate and may request a different amount of data if the recipient is using a cable modem to communicate. Additionally or alternatively, the amount of data may be selected by the provider based on any information known and/or available to the provider.

Additionally or alternatively, the amount of data may be selected based on a prediction of the type of connection being used to establish communications between the recipient and the provider. The prediction of the type of connection may be based on the geographic region of the recipient and the provider and the types of connections (e.g., modem, ISDN, DSL, xDSL, cable modem, X.25, TCP and/or satellite) that are available to that particular region.

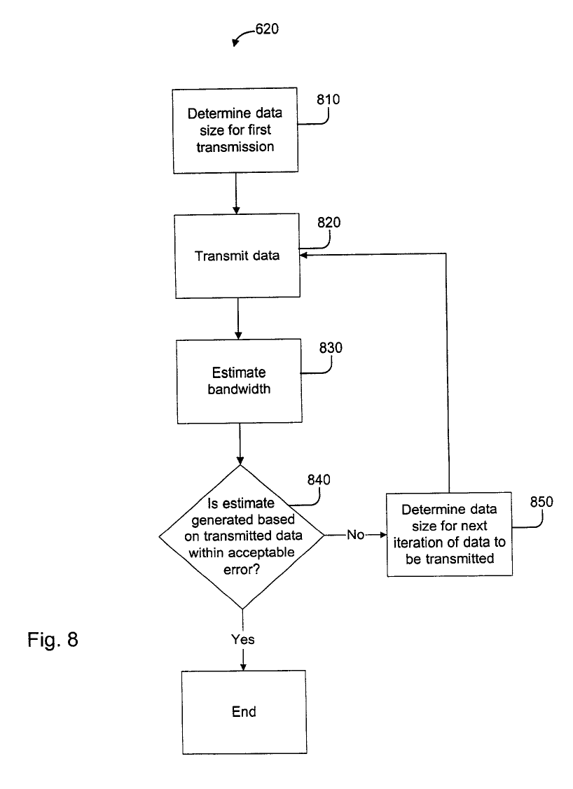

In one implementation, the process of automatically determining the available bandwidth (step 620) may be performed several times or with several iterations to improve the accuracy of the bandwidth calculation. Referring to FIG. 8, the first amount of data may be determined by either the provider or the recipient (step 810). For example, a small amount of data may be used during a first iteration, so that other communications between the provider and the recipient are not perceptibly affected by the speed detecting process. More specifically, to prevent delayed communications on low bandwidth connections (e.g., dial-up, cellular, or ISDN), the first iteration may involve an amount of data sized for rapid transmission and receipt, even on a low bandwidth connection. Additionally or alternatively, the first amount of data may be based on a prediction of the type of connection being used to establish communications between the recipient and the provider, as described above. Once the first amount of data is determined (step 810), the data is transmitted to the recipient (step 820). Following the transmission of the data (step 820), the available bandwidth is calculated based on the small amount of data (step 830). The estimated available bandwidth may be compared to a threshold level to determine if the threshold level has been exceeded (step 840). If the threshold level has been exceeded, a second iteration may be performed to verify the estimated available bandwidth.

For the second iteration, a new amount of data to be transmitted is determined (step 850). The second iteration may include a larger amount of data than the first iteration. For instance, the amount of data for the second iteration may be selected based on the calculated bandwidth that was determined during the first iteration, or it may be selected based on the first or previous iteration's amount of data using, e.g., a predetermined algorithm. Additionally or alternatively, the second amount of data may be smaller than the first amount of data. Subsequent iterations may include varying the amount of data (i.e., by increasing or decreasing the amount) to more accurately measure the available bandwidth and, thus, determine the download and/or upload speeds.

The type of data used to determine the available bandwidth may be any type of data of a known size. For example, the type of data may include compressed data, uncompressed data, and any combination of these types of data.

The available bandwidth between a recipient and a provider may be determined automatically at various stages of the communication between the recipient and the provider. For example, the determination may be made while a connection is being established between the recipient and the provider, such as, during a login process. Additionally or alternatively, the determination may be made once a communication session has been established between the recipient and the provider, such as, after a login process. The automatic determination of the available bandwidth may be initiated by either the recipient or the provider, and the bandwidth may be recalculated at any time during a communication session. For instance, recalculating the available bandwidth during an established communication session may be necessary to account for varying network speeds during a particular session.

The determination of the available bandwidth between the recipient and the provider may occur over one or more types of connections. The types of connections may include, for example, a wide area network (WAN), a local area network (LAN), a low bandwidth connection (e.g., dial-up, cellular, or ISDN), a cable modem, DSL, xDSL, satellite, X.25, TCP, or any combination of these types of connections.

Referring again to FIG. 6, automatically determining an available bandwidth between a recipient and a provider (step 620) also may include automatically determining an available bandwidth between the recipient and the provider on multiple channels simultaneously. For example, the provider may send a request to the recipient for a bandwidth determination on several channels simultaneously. This may be useful for selecting the content to provide over each channel, as discussed below.

The automatic determination of an available bandwidth between the recipient and the provider may include using any one of the methods or combination of the methods to determine the available bandwidth, as described above. For instance, the bandwidth may be determined bi-directionally over multiple channels at the same time. Also, for instance, the bandwidth may be determined automatically over a channel accommodating communications from the recipient to the provider and separately may be determined automatically over a channel accommodating communications from the provider to the recipient. The automatic determination of bandwidth is scalable and may be used to determine an available bandwidth using any type of criteria defined by the recipient and/or the provider. In one example implementation, an initial satellite “up” link may be established using a phone line from the recipient to the provider. The return “down” link of the communication path from the provider to the recipient may be over a channel separate from the up link. The available bandwidth may be automatically determined separately for the up link and the down link. For example, the available bandwidth on the initial up link may be determined to be 28.8 Kb. The down link may separately be determined to be 1.5 Mb. The appropriate content may be selected to be communicated based on the automatically determined available bandwidths. If the satellite connection becomes unavailable and connection with the satellite is lost, then the content may be delivered back on the phone line. A subsequent automatic determination of the available bandwidth will determine that the relatively large available bandwidth associated with the satellite connection is no longer available and the content being communicated may be changed based on a new automatically determined available bandwidth for the phone line. Alternatively, the content may be changed based on the initial determined available bandwidth (28.8 Kb) over the phone line.

Based on the automatic determination of the available bandwidth, a type of content may be selected for communication between the recipient and the provider (step 640). For example, the provider may select the type of content to be communicated based on whether or not a threshold amount of bandwidth is available. If the available bandwidth is above the threshold, the provider may select a type of content that is more effectively communicated when using a bandwidth above the threshold bandwidth. By contrast, if the available bandwidth is below the threshold, the provider may select a type of content that is appropriate when using a bandwidth below the threshold bandwidth. Additionally or alternatively, a range of bandwidths may be used to determine the type of content to communicate between the recipient and the provider based on the range within which the determined available bandwidth falls.

The type of content communicated between the provider and the recipient may vary by format, richness, subject matter and/or any combination of these content types, based on the determined available bandwidth. For instance, formats of content may include text, audio, still pictures, animation, slide shows, partial video, streaming video, full-motion video, and any combination of these formats. Because one available bandwidth (e.g., bandwidth available using a 28.8K modem) may not be effective for communicating content that includes the full-motion video format, content of a more appropriate format may be selected for communication based on a determination of that bandwidth, e.g., the still picture format. With respect to subject matter, for example, some information may be omitted in smaller bandwidth communications.

The richness of the content typically refers to the quality, resolution, appearance, and type of features associated with the content. For instance, if the content includes still images, then the richness may refer to the resolution of the images. If the content includes video, then the richness may refer to the frame rate of the video. For dynamic content (e.g., highlights of a live sporting event), the richness may refer to the frequency of the updates to the content.

Additionally or alternatively, an available bandwidth that is determined for multiple channels simultaneously may be used to provide content over each channel. The content provided over each channel may be the same or may be different. For example, a web browser may open multiple channels simultaneously to fetch and provide content of different formats from a web page. The provider may use the bandwidth determined over multiple channels simultaneously to select the content provided to the recipient over each channel.

In addition to automatically determining an available bandwidth to select the type of content provided, an available bandwidth may be determined for a specific type of data. For instance, it may be desirable to know the available bandwidth for compressed data, audio data, video data, uncompressed data, or any type of data, or combination of data types.

The numerous methods, systems, and computer programs described above for automatically determining an available bandwidth between a recipient and a provider and selecting content to be communicated between the recipient and the provider based on the determined available bandwidth may be independent of any and all lower level transport channels, protocols, and network designs that may communicate content that is dependent upon an available bandwidth.

The described systems, methods, and techniques may be implemented in digital electronic circuitry, computer hardware, firmware, software, or in combinations of these elements. Apparatus embodying these techniques may include appropriate input and output devices, a computer processor, and a computer program product tangibly embodied in a machine-readable storage device for execution by a programmable processor. A process embodying these techniques may be performed by a programmable processor executing a program of instructions to perform desired functions by operating on input data and generating appropriate output. The techniques may be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, a processor will receive instructions and data from a read-only memory and/or a random access memory. Storage devices suitable for tangibly embodying computer program instructions and data include all forms of non-volatile memory, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks; magneto-optical disks; and Compact Disc Read-Only Memory (CD-ROM). Any of the foregoing may be supplemented by, or incorporated in, specially-designed ASICs (application-specific integrated circuits).

Other implementations are within the scope of the following claims.

What is claimed is:

1. A method of communicating content, the method comprising:
automatically determining an available bandwidth between a recipient and a provider;
selecting content to be communicated between the recipient and the provider based on the available bandwidth determined; and
communicating the content selected between the provider and the recipient.

2. The method of claim 1 wherein the available bandwidth is determined automatically using at least one iteration comprising:
transmitting a predetermined amount of data to the recipient;
monitoring an amount of time taken for the predetermined amount of data to be received by the recipient; and
calculating the available bandwidth based on the predetermined amount of data and the amount of time taken for the data to be received by the recipient.

3. The method of claim 2 wherein transmitting the data comprises transmitting an amount of data determined based on a prediction of a communication device used by the recipient to communicate.

4. The method of claim 2 wherein automatically determining the available bandwidth further comprises:
transmitting information indicating the amount of data being communicated to the recipient,
wherein calculating the available bandwidth comprises calculating the available bandwidth at the recipient based on the information indicating the amount of data communicated and the amount of time for the transmission.

5. The method of claim 2 wherein calculating the available bandwidth comprises calculating the available bandwidth at the provider based on the amount of data and the amount of time for the transmission.

6. The method of claim 1 wherein automatically determining the available bandwidth comprises:
transmitting a predetermined amount of data to the recipient;
re-transmitting the predetermined amount of data to the provider;
monitoring an amount of time taken for the predetermined amount of data to be received by the recipient, re-transmitted to the provider, and received by the provider; and
calculating the available bandwidth based on the predetermined amount of data and the amount of time taken for the data to be received by the recipient, re-transmitted to the provider, and received by the provider.

7. The method of claim 6 wherein automatically determining the available bandwidth further comprises:
transmitting information indicating the amount of data being communicated to the recipient;
wherein calculating the available bandwidth comprises calculating the available bandwidth at the recipient based on the information indicating the amount of data communicated and the amount of time taken for the data to be received by the recipient, retransmitted to the provider, and received by the provider.

8. The method of claim 6 wherein calculating the available bandwidth comprises calculating the available bandwidth at the provider based on the amount of data and the amount of time taken for the data to be received by the recipient, re-transmitted to the provider, and received by the provider.

9. The method of claim 2 wherein automatically determining the available bandwidth further comprises:
adjusting the predetermined amount of data based on the available bandwidth calculated; and
repeating the iteration using the adjusted predetermined amount of data.

10. The method of claim 9 wherein adjusting the predetermined amount of data comprises increasing the predetermined amount of data.

11. The method of claim 9 wherein adjusting the predetermined amount of data comprises decreasing the predetermined amount of data.

12. The method of claim 1 wherein automatically determining the available bandwidth comprises automatically detecting the available bandwidth between the recipient and the provider.

13. The method of claim 1 wherein automatically determining the available bandwidth is performed when the recipient initially establishes communications with the provider.

14. The method of claim 1 wherein automatically determining the available bandwidth is performed when the recipient requests content from the provider after the recipient initially establishes communications with the provider.

15. The method of claim 1 wherein selecting content comprises selecting among content of varying richnesses based on the available bandwidth determined.

16. The method of claim 1 wherein selecting content comprises selecting among content of varying formats based on the available bandwidth determined.

17. The method of claim 16 wherein selecting among content of varying formats comprises selecting between at least content in a still picture format and content in a video format depending up on the available bandwidth determined.

18. The method of claim 1 wherein the recipient is a client and the provider is a host.

19. The method of claim 1 wherein the recipient is a host and the provider is a client.

20. The method of claim 1 wherein the recipient and the provider are both client devices.

21. The method of claim 20 wherein the recipient and the provider are both capable of peer-to-peer communications.

22. The method of claim 1 wherein automatically determining an available bandwidth includes automatically detecting the available bandwidth several times during one communication session between the recipient and the provider.

23. The method of claim 1 wherein automatically determining an available bandwidth includes automatically determining the available bandwidth over a channel accommodating communications from the recipient to the provider and separately automatically determining the available bandwidth over a channel accommodating communications from the provider to the recipient.

24. The method of claim 1 wherein automatically determining an available bandwidth includes automatically determining the available bandwidth over multiple channels between the recipient and the provider.

25. The method of claim 24 wherein automatically determining the available bandwidth over multiple channels includes automatically determining the available bandwidth simultaneously over multiple channels between the recipient and the provider.

26. The method of claim 24 further comprising selecting differing content to be communicated over the multiple channels between the recipient and the provider based on the available bandwidth determined over the multiple channels.

27. The method of claim 1 wherein automatically determining an available bandwidth includes automatically determining the available bandwidth simultaneously from the provider to the recipient and from the recipient to the provider.

28. A computer program for communicating content, the computer program being stored on a computer readable medium or a propagated signal and comprising:
an automatic determining code segment that causes the computer automatically to determine an available bandwidth between a recipient and a provider;
a selecting code segment that causes the computer to select content to be communicated between the recipient and the provider based on the available bandwidth determined; and
a communicating code segment that causes the computer to communicate the content selected between the provider and the recipient.

29. The computer program of claim 28 wherein the automatic determining code segment causes the computer to perform an iteration comprising:
a transmitting code segment that causes the computer to transmit a predetermined amount of data to the recipient;
a monitoring code segment that causes the computer to monitor an amount of time taken for the predetermined amount of data to be received by the recipient; and
a calculating code segment that causes the computer to calculate the available bandwidth based on the predetermined amount of data and the amount of time taken for the data to be received by the recipient.

30. The computer program of claim 29 wherein the transmitting code segment causes the computer to transmit an amount of data determined based on a prediction of a communication device used by the recipient to communicate.

31. The computer program of claim 29 wherein the automatic determining code segment comprises:
a transmitting code segment that causes the computer to transmit information indicating the amount of data being communicated to the recipient,
wherein the calculating code segment causes the computer to calculate the available bandwidth at the recipient based on the information indicating the amount of data communicated and the amount of time for the transmission.

32. The computer program of claim 29 wherein the calculating code segment causes the computer to calculate the available bandwidth at the provider based on the amount of data and the amount of time for the transmission.

33. The computer program of claim 28 wherein the automatic determining code segment comprises:
a transmitting code segment that causes the computer to transmit a predetermined amount of data to the recipient;
a re-transmitting code segment that causes the computer to re-transmit the predetermined amount of data to the provider;
a monitoring code segment that causes the computer to monitor an amount of time taken for the data of the predetermined size to be received by the recipient, re-transmitted to the provider, and received by the provider; and
a calculating code segment that causes the computer to calculate the available bandwidth based on the predetermined amount of data and the amount of time taken for the data to be received by the recipient, re-transmitted to the provider, and received by the provider.

34. The computer program of claim 33 wherein the automatic determining code segment further comprises:
a transmitting code segment that causes the computer to transmit information indicating the amount of data being communicated to the recipient,
wherein the calculating code segment causes the computer to calculate the available bandwidth at the recipient based on the information indicating the amount of data communicated and the amount of time taken for the data to be received by the recipient, retransmitted to the provider, and received by the provider.

35. The computer program of claim 34 wherein the calculating code segment causes the computer to calculate the available bandwidth at the provider based on the amount of data and the amount of time taken for the data to be received by the recipient, retransmitted to the provider, and received by the provider.

36. The computer program of claim 29 wherein the automatic determining code segment further comprises:
an adjusting code segment that causes the computer to adjust the predetermined amount of data based on the available bandwidth calculated; and
a repeating code segment that causes the computer to repeat the iteration using the adjusted predetermined amount of data.

37. The computer program of claim 36 wherein the adjusting code segment causes the computer to increase the predetermined amount of data.

38. The computer program of claim 36 wherein the adjusting code segment causes the computer to decrease the predetermined amount of data.

39. The computer program of claim 28 wherein the automatic determining code segment comprises an automatic detecting code segment that causes the computer to automatically detect the available bandwidth between the recipient and the provider.

40. The computer program of claim 28 wherein the automatic determining code segment causes the computer to determine automatically the available bandwidth when the recipient initially establishes communications with the provider.

41. The computer program of claim 28 wherein the automatic determining code segment causes the computer to determine automatically the available bandwidth when the recipient requests content from the provider after the recipient initially establishes communications with the provider.

42. The computer program of claim 28 wherein the selecting code segment causes the computer to select among content of varying richnesses based on the available bandwidth determined.

43. The computer program of claim 28 wherein the selecting code segment causes the computer to select among content of varying formats based on the available bandwidth determined.

44. The computer program of claim 43 wherein the selecting code segment causes the computer to select between at least content in a still picture format and content in a video format depending upon the available bandwidth determined.

45. The computer program of claim 28 wherein the recipient is a client and the provider is a host.

46. The computer program of claim 28 wherein the recipient is a host and the provider is a client.

47. The computer program of claim 28 wherein the recipient and the provider are both client devices.

48. The computer program of claim 47 wherein the recipient and the provider are both capable of peer-to-peer communications.

49. The computer program of claim 28 wherein the automatic determining code segment causes the computer to detect automatically the available bandwidth several times during one communication session between the recipient and the provider.

50. The computer program of claim 28 wherein the automatic determining code segment causes the computer to determine automatically the available bandwidth over a channel accommodating communications from the recipient to the provider and separately to determine automatically the available bandwidth over a channel accommodating communications from the provider to the recipient.

51. The computer program of claim 28 wherein the automatic determining code segment causes the computer to determine automatically the available bandwidth over multiple channels between the recipient and the provider.

52. The computer program of claim 51 wherein the automatic determining code segment causes the computer to determine automatically the available bandwidth simultaneously over multiple channels between the recipient and the provider.

53. The computer program of claim 51 wherein the selecting code segment causes the computer to select differing content to be communicated over the multiple channels between the recipient and the provider based on the available bandwidth determined over the multiple channels.

54. The computer program of claim 28 wherein the automatic determining code segment causes the computer to determine automatically the available bandwidth simultaneously from the provider to the recipient and from the recipient to the provider.

55. A system for communicating content, the system comprising:
an automatic determining component that is structured and arranged to determine automatically an available bandwidth between a recipient and a provider;
a selecting component that is structured and arranged to select content to be communicated between the recipient and the provider based on the available bandwidth determined; and
a communicating component that is structured and arranged to communicate the content selected between the provider and the recipient.

56. The system of claim 55 wherein the automatic determining component performs an iteration comprising:
a transmitting component that is structured and arranged to transmit a predetermined amount of data to the recipient;
a monitoring component that is structured and arranged to monitor an amount of time taken for the predetermined amount of data to be received by the recipient; and
a calculating component that is structured and arranged to calculate the available bandwidth based on the predetermined amount of data and the amount of time taken for the data to be received by the recipient.

57. The system of claim 56 wherein the transmitting component is structured and arranged to transmit an amount of data determined based on a prediction of a communication device used by the recipient to communicate.

58. The system of claim 56 wherein the automatic determining component comprises:
a transmitting component that is structured and arranged to transmit information indicating the amount of data being communicated to the recipient,
wherein the calculating component is structured and arranged to calculate the available bandwidth at the recipient based on the information indicating the amount of data communicated and the amount of time for the transmission.

59. The system of claim 56 wherein the calculating component is structured and arranged to calculate the available bandwidth at the provider based on the amount of data and the amount of time for the transmission.

60. The system of claim 55 wherein the automatic determining component comprises:
a transmitting component that is structured and arranged to transmit a predetermined amount of data to the recipient;
a re-transmitting component that is structured and arranged to re-transmit the predetermined amount of data to the provider;
a monitoring component that is structured and arranged to monitor an amount of time taken for the predetermined amount of data to be received by the recipient, re-transmitted to the provider, and received by the provider; and
a calculating component that is structured and arranged to calculate the available bandwidth based on the predetermined amount of data and the amount of time taken for the data to be received by the recipient, re-transmitted to the provider, and received by the provider.

61. The system of claim 60 wherein the automatic determining component further comprises:
a transmitting component that is structured and arranged to transmit information indicating the amount of data being communicated to the recipient,
wherein the calculating component is structured and arranged to calculate the available bandwidth at the recipient based on the information indicating the amount of data communicated and the amount of time taken for the data to be received by the recipient, retransmitted to the provider, and received by the provider.

62. The system of claim 61 wherein the calculating component is structured and arranged to calculate the available bandwidth at the provider based on the amount of data and the amount of time taken for the data to be received by the recipient, re-transmitted to the provider, and received by the provider.

63. The system of claim 56 wherein the automatic determining component further comprises:
an adjusting component that is structured and arranged to adjust the predetermined amount of data based on the available bandwidth calculated; and
a repeating component that is structured and arranged to repeat the iteration using the adjusted predetermined amount of data.

64. The system of claim 63 wherein the adjusting component increases the predetermined amount of data.

65. The system of claim 63 wherein the adjusting component decreases the predetermined amount of data.

66. The system of claim 55 wherein the automatic determining component comprises an automatic detecting component that is structured and arranged to detect automatically the available bandwidth between the recipient and the provider.

67. The system of claim 55 wherein the automatic determining component is structured and arranged to determine automatically the available bandwidth when the recipient initially establishes communications with the provider.

68. The system of claim 55 wherein the automatic determining component is structured and arranged to determine automatically the available bandwidth when the recipient requests content from the provider after the recipient initially establishes communications with the provider.

69. The system of claim 55 wherein the selecting component is structured and arranged to select among content of varying richnesses based on the available bandwidth determined.

70. The system of claim 55 wherein the selecting component is structured and arranged to select among content of varying formats based on the available bandwidth determined.

71. The system of claim 70 wherein the selecting component is structured and arranged to select between at least content in a still picture format and content in a video format depending upon the available bandwidth determined.

72. The system of claim 55 wherein the recipient is a client and the provider is a host.

73. The system of claim 55 wherein the recipient is a host and the provider is a client.

74. The system of claim 55 wherein the recipient and the client are both client devices.

75. The system of claim 74 wherein the recipient and the provider are both capable of peer-to-peer communications.

76. The system of claim 55 wherein the automatic determining component is structured and arranged to detect automatically the available bandwidth several times during one communication session between the recipient and the provider.

77. The system of claim 55 wherein the automatic determining component is structured and arranged to determine automatically the available bandwidth over a channel accommodating communications from the recipient to the provider and separately to determine automatically the available bandwidth over a channel accommodating communications from the provider to the recipient.

78. The system of claim 55 wherein the automatic determining component is structured and arranged to determine automatically the available bandwidth over multiple channels between the recipient and the provider.

79. The system of claim 78 wherein the automatic determining component is structured and arranged to determine automatically the available bandwidth simultaneously over multiple channels between the recipient and the provider.

80. The system of claim 78 wherein the selecting component is structured and arranged to select differing content to be communicated over the multiple channels between the recipient and the provider based on the available bandwidth determined over the multiple channels.

81. The system of claim 55 wherein the automatic determining component is structured and arranged to determine automatically the available bandwidth simultaneously from the provider to the recipient and from the recipient to the provider.
